(19) United States
(12) Patent Application Publication
(10) Pub. No.: US 2009/0144461 A1
(43) Pub. Date: Jun. 4, 2009

(54) METHOD AND SYSTEM FOR CONFIGURATION OF A HARDWARE PERIPHERAL

(76) Inventors: Alexander Lampe, Redhill Surrey (GB); Peter Bode, Redhill Surrey (GB); Stefan Koch, Redhill Surrey (GB); Wolfgang Lesch, Redhill Surrey (GB)

Correspondence Address: SEED INTELLECTUAL PROPERTY LAW GROUP PLLC, 701 FIFTH AVENUE, SUITE 5400, SEATTLE, WA, 98104-7092, US

(21) Appl. No.: 12/347,567

(22) Filed: Dec. 31, 2008

Related U.S. Application Data
(63) Continuation-in-part of application No. PCT/IB2007/052428, filed on Jun. 22, 2007.

(30) Foreign Application Priority Data
Jul. 3, 2006 (EP) 06116519.7

(51) Int. Cl. G06F 13/28

(52) U.S. Cl. 710/22

(57) ABSTRACT

The present disclosure relates to a method for re-configuration of a hardware peripheral, and a system that includes the hardware peripheral. Processing of large amounts of data in a multifunctional environment in a processor system is enabled in a flexible way by employing a re-configurable and autonomous operating hardware peripheral, which receives and, if necessary, sends data independently of a processor by use of DMA channels. Furthermore, the re-configuration method enables flexible assembling and storing of at least one set of configuration parameters used for the re-configuration of the hardware peripheral. The present disclosure provides the advantage of a flexible and fast way of handling large amounts of temporary data independently of a processor.

### BACKGROUND

1. Technical Field

The present disclosure relates to a method for re-configuration of a hardware peripheral, a hardware peripheral, and a system comprising the hardware peripheral.

2. Description of the Related Art

Mobile computing devices are provided with more and more integrated features. For instance, previous voice centric phones had little integrated functionality, and the supported functionality required only a limited amount of data transfer. Modern devices embed more functions on one processor, and have to cope with high data bandwidth caused by handling of JPEG, M-JPEG, MPEG4, and snapshot GPS data and the like. The necessary amount of data flows when handling those data in a device equipped with limited processing capacity causes high system load for a few seconds, or in case of some applications, even over a longer period of time.

To deal with problems arising from multi-functionality and processing of large amounts of data, in particular temporary data, in processor systems, several methodologies have been developed. A flexible solution may be to have re-configurable hardware processors in the system, of which processor an actual performed processing function can be configured for a certain processing function that is actually needed.

For that purpose, in a first approach re-configuration parameters may be generated by means of a dedicated processor inside the re-configurable hardware processor. This would be very flexible but it would mean significant effort to design such a dedicated processor into the re-configurable hardware processors. A further aspect would be the required chip size. Software running on the dedicated processor may be an implementation of a Finite State Machine (FSM), where the term FSM is to be understood very generally. In principle, every system that can take discrete states and that has memory may be considered as an FSM. In order to produce the needed configuration parameters, one can download the dedicated processor's program or at least parts of it from the system processor.

Another approach may be to generate the parameter by means of dedicated hardware inside the re-configurable hardware processors. Such dedicated hardware can implement an FSM, but it would be less flexible than a dedicated processor or it would turn into a kind of custom processor that is complex to develop.

As a third approach, the parameter may be generated in the system processor and sent to the re-configurable hardware processors via involvement of the system processor, for example by means of an interrupt service routine or polling. However, this would make suboptimum use of the re-configurable hardware processors because the system processor may be busy when the re-configurable hardware processor has finished its previous job.

Thus, the solutions discussed above are still too complex with regard to time and/or space, too inflexible, or too dependent on their environment or on the power of the system processor, respectively. Consequently, there is still an increasing need for further developed systems, methods and/or hardware components capable of efficiently dealing with large amounts of data in a multifunctional environment of a processor system.

### BRIEF SUMMARY

The present disclosure facilitates and improves processing of large amounts of data in and multi-functionality of a processor system. The design of the processor systems are improved such that the system, in particular the system processor, is capable of performing its tasks or functions more efficiently.

Accordingly, a method for re-configuration of a hardware peripheral performing at least one function for or in a system with at least one processor is provided, the method including the steps of transferring a set of configuration parameters for the hardware peripheral from at least one first data source to the hardware peripheral via at least one first DMA channel, and re-configuring the hardware peripheral with the set of configuration parameters.

The hardware peripheral for performing at least one function for a system with at least one processor is configured to receive a set of configuration parameters for re-configuration of the at least one function from at least one first data source via at least one first DMA channel, and wherein the hardware peripheral is configured to be re-configured with the received set of configuration parameters.

A system for processing a high amount of temporary data is also provided, the system including at least one processor and a hardware peripheral according to the disclosure, such that processor load caused by handling of the high amount of temporary data is reduced.

In accordance with another aspect of the present disclosure, a circuit is provided that includes a hardware accelerator for a peripheral having co-processor behavior; at least one DMA channel adapted to receive data regarding the function on an input and to output the data to the accelerator; and at least one second DMA channel adapted to transfer data from the accelerator to at least one data destination for reconfiguration of the function.

In accordance with another aspect of the foregoing embodiment, the source of data input to the DMA channel and the destination of the data output through the at least second DMA channel comprises a single memory.

In accordance with another aspect of the foregoing embodiment, the data input through the DMA channel and output through the at least second DMA channel is sent and received independent of an external processor.

As a result, a hardware peripheral, for example a type of computer hardware added to a processor system in order to expand its abilities or functionality, is provided, which can perform several tasks or functions. For example certain functions for data processing are performed, wherein the hardware peripheral is capable of processing portions of the whole data of any or predetermined size. Advantageously, for each new processing step the hardware peripheral can be respectively re-configured according to the actual set of configuration parameters set up for the corresponding processing step. Data to be processed by the hardware peripheral is transferred by direct memory access initiated by the hardware peripheral via at least one DMA channel such that an involvement of the system processor is not required. And of course, a portion of data can also comprise the whole data being provided and the set of configuration parameters can also be empty.

The direct memory access (DMA) concept and a DMA channel working with the DMA concept are essential features of modern processor devices. Basically, it allows transfer of data without subjecting an involved processor. In data transfer via DMA essentially a part of a memory is copied from one device to another. While the involved processor may initiate the data transfer by a respective DMA request, it does not execute the transfer itself. Accordingly, a DMA operation does not stall the processor, which as a result can be scheduled to perform other tasks. Hence, DMA transfers are essential to high performance embedded systems.

It is worth noting that the terms “configuration” or “to configure” may be used, instead of the used terms “re-configuration” or “to re-configure”, herein. However, the flexibility provided by the method and apparatus disclosed herein, is in particular seen in the re-configurability of a hardware peripheral. In other words, a hardware peripheral is provided that is capable of dynamically changing its behavior, for instance, in response to dynamic changes in its environment or the data to be processed. A set of configuration parameters may be used, for example, as algorithmic configuration parameters, which configure or adapt a certain algorithmic function of the hardware peripheral. Consequently, also the method and the system are related to a configurable or re-configurable, respectively, hardware peripheral. The terms “configuration” and/or “to configure” may also be used as terms including the first configuration and the possible next or proximate configurations or re-configurations respectively.

Amongst other advantages are low complexity, high flexibility, and high autonomy obtained by the solution provided herein, when dealing with the above-discussed problems concerning high amounts of data and the requirement of fast computing and ability to support multi-functionality of a processor system. In this context, “autonomy” means that the re-configuration by means of a set of configuration parameters does not occur under control of the system processor, for instance, by interrupt service routines, because this may cause unused idle time in the hardware peripheral if the system processor is busy with higher priority tasks. Thus, the hardware peripheral is enabled to perform this functionality independently of the system processor. “Autonomy” means also that the hardware peripheral is enabled to pull the configuration parameters autonomously, wherein the transfer of data or configuration parameters, respectively, is implemented independently of the system processor. That is to say the system processor does not initiate the transfer of the data. DMA channels are used to transfer the data as well as the set of configuration parameters from a data source, for example, from at least one memory means, which can be also the system memory. “Flexibility” refers to the free choice of the configuration parameters.

Furthermore, the at least one set of configuration parameters, for example a sequence of configuration parameter settings for the hardware peripheral, may be assembled in at least one data pre-processing circuit. Further, the at least one set of configuration parameters for the hardware peripheral can be stored in at least one memory, which preferably is the system memory of the processor system. The at least one memory may also be a memory of a re-configurable hardware processor of the hardware peripheral, the system processor or a memory in another component of the processor system.

Furthermore, for assembling or generating of the sets of configuration parameters, several techniques or means are possible and can be involved. A set of configuration parameters for the re-configuration of the hardware peripheral can be received from an external or internal source or even computed or assembled by appropriate means or functions before being transmitted to the hardware peripheral via at least one DMA channel.

In one embodiment, a device for assembling or acquiring at least one set of configuration parameters for re-configuration of the hardware peripheral are implemented by a Finite State Machine (FSM), which is adapted to generate the required sets of configuration parameters, for example algorithmic configuration parameters, in a desired or predetermined order.

It is to be noted that choosing appropriate means for assembling or acquiring the at least one set of configuration parameters is to be seen as a trade-off between flexibility and complexity. Consequently, advantages of flexibility and autonomy are provided and limitations or complexity of the FSMs of conventional approaches can be avoided.

The data processed in the hardware peripheral, the resulting data, can also be transferred from the hardware peripheral by direct memory access via at least one DMA channel to at least one data destination, for example a memory, which preferably is the system memory or means for further processing of the result data.

Further, in one embodiment the hardware peripheral is a hardware accelerator or a peripheral with co-processor behavior. In one application, such a hardware accelerator is a Global Positioning System (GPS) hardware accelerator (GHA). Here, the data to be processed may be snapshot GPS data as input (raw) data, where resultant data output by the GHA may comprise compressed data in certain cases but the amount of output data may even be increased.

Thus, a flexible, less complex, and autonomously working method, components, and a system are disclosed, where a hardware peripheral for a processor system is configured or re-configured respectively, wherein the at least one set of configuration parameters are transferred in the hardware peripheral independently of a system processor by direct memory access as well as data source or data destination are accessed by the hardware peripheral via direct memory access independently of the system processor.

### BRIEF DESCRIPTION OF THE SEVERAL VIEWS OF THE DRAWINGS

The present disclosure will now be described in more detail based on embodiments thereof with reference to the attached drawings, in which:

FIG. 1 is a block diagram that schematically illustrates the information flow into and out of a core signal processing function F of a GHA;

FIG. 2 is a block diagram that schematically illustrates the attachment of the GHA to a processor system; and

FIG. 3 illustrates utilization of sets of configuration parameters, data vectors transferred from memory to the GHA, and transfer of resulting vectors from the GHA to memory means.

### DETAILED DESCRIPTION

As stated above, modern processor equipped devices include more and more integrated features, embedding more and more tasks or functions on one processor, which is subjected by the load of handling large amounts of data besides other processing tasks. According to the present disclosure, at least one task or function is outsourced to a re-configurable hardware peripheral. In the following, the at least one task or function is reduced to a black box, which is assumed to contain at least one configurable function or task referred to as F in the following.

Now, one embodiment will be described in more detail, wherein a GPS (Global Positioning System) hardware accelerator (GHA) is taken as an example for a re-configurable hardware peripheral. Thus, it is clear that the present disclosure is not to be limited by the embodiment. In other words, the GHA is used to illustrate the principles and basic features of the present disclosure, but it is not intended to limit the disclosure thereto.

In a GPS receiver, one of the computationally most expensive tasks is the initial synchronization to the GPS signals arriving from the GPS satellites. Synchronization includes estimating of characteristics of the GPS signals, primarily code phases and Doppler shifts. This can be accomplished by means of matched filters (MFs). A single MF is used to estimate the code phase of a GPS satellite with known spreading code and known Doppler shift. As the signal is noisy, the MF needs to have a very long finite impulse response (FIR), which may last hundreds of thousands of samples or more. If spreading codes and Doppler shifts are unknown, a 2-dimensional bank of very long matched filters is required.

In the embodiment, it is assumed that GPS baseband data has been stored into a system memory of the GPS receiver in which they are available for post processing by appropriate algorithms and can be re-accessed as often as required. In this context, the GHA is assumed to provide the function of chip rate processing of the GPS baseband signal, which is stored in a system memory as data to be processed.

At least one (sequential) call or request of the function F provided by the GHA is performed, wherein configuration parameters for the function F and for the GHA, respectively, can change from call to call or request to request, respectively. In other words, after every call or request of the function F of the GHA, a re-configuration of the GHA with a respective set of configuration parameters can be performed. However, it is also possible that the function F is used consecutively without change, that is re-configuration. The next data is processed after the corresponding call or request by the GHA, accordingly.

The transfer of the data and/or configuration parameters is performed via DMA channels. Further, as will be shown below, the settings of the GHA can be changed flexibly by means of the predetermined sets of configuration parameters in an autonomous way with low complexity.

Furthermore, the processed result data of the GHA are transferred via a DMA channel independently of the system processor to at least one data destination, for example memory means or means for further processing of the result data. In the following, it is assumed that the data destination is the system memory.

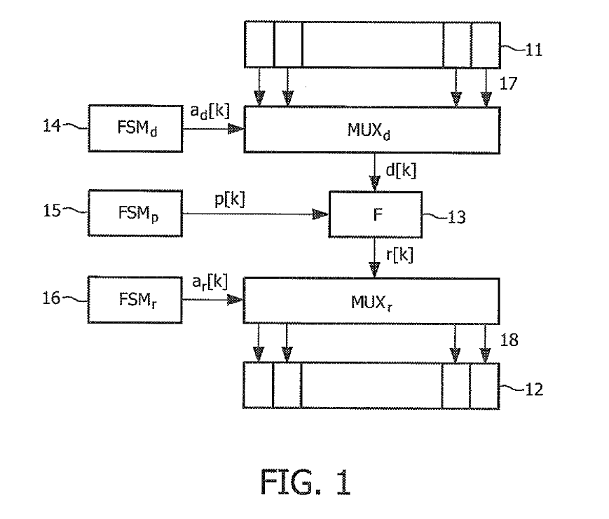

FIG. 1 illustrates the information flow into and out of a core signal processing function F of a GHA attached to a GPS receiver as a processor system. That is to say, the GHA serves as an example of a re-configurable hardware peripheral according to the present disclosure.

In the following, at first the function F, which represents the re-configurable part of the GHA, will be discussed in more detail. In this embodiment, the function F is performed by an appropriate processing device 13 of the GHA, and data 17 used as input of the function F originates from the data memory 11.

Basically, the function F maps a data vector d[k] on a result vector r[k] in dependency of the configuration of the function F set by a configuration parameter vector p[k] as a set of configuration parameters. This is expressed by equation (1), below.

r[k]=F{d[k],p[k]} (1),

wherein the variable k is the time index. It is to be noted that variable k should not be confused with the cycle number of a processing system. Further, usually it will need several processor cycles to compute the equation (1).

The elements of the data vectors at time k are given by dₙ[k] with 1≦n≦N_{d}, the elements of the configuration parameter vectors at time k are given by pₙ[k] with 1≦n≦Nₚ, and the elements of the result vectors at time k are given by rₙ[k] with 1≦n≦Nᵣ. The corresponding vector sizes N_{d}, Nₚ, and Nᵣ may depend on the time index k or it may be fixed.

The elements dₙ[k] of the data vector d[k] are samples of the GPS base band signal, which may be real valued or a complex valued. The elements rₙ[k] of the result vector r[k] are in turn in the most cases complex valued and essentially represent the dot products between the data vector d[k] and Nᵣ vectors of spreading codes. Further, the elements pₙ[k] of the configuration parameter vector p[k] may be real valued or a complex valued and determine the properties of the spreading code vectors, which are generated within the function F.

The data vectors d[k] are fetched from the data memory 11 holding the GPS base band signal as the data 17 to be processed by the GHA, which in turn is partitioned into vectors D(a_{d}). Thus, a data vector d[k] can be written as:

d[k]=D(a_{d}[k]) (2),

wherein the index a_{d} identifies a sequence of samples from D, which may be arbitrarily scattered but which are consecutive in the most cases. The indices a_{d}[k] are generated by the FSM_{d}. The sequence a_{d}[k] depends on the respective processing strategy and is in principle arbitrary.

The finite state machine FSMₚ can be used for assembling or acquiring or both assembly and acquiring the sets of configuration parameters for re-configuration of the processing device 13 of the GHA, wherein the FSMₚ is performed in an appropriate circuit 15 in a known manner. The set of reconfiguration parameters, for example algorithmic configuration parameters, are generated by the FSMₚ in a desired and/or predetermined order. A configuration parameter vector p[k] produced in this way depends on the respective processing strategy and can be arbitrary.

The sets of configuration parameters can be assembled, for example, by the system processor of the GPS receiver (not shown) and stored in the system memory before being transferred to the GHA and used for the re-configuration of the processing means 13 of the GHA. The transfer of the data or data vectors, respectively, and the sets of configuration parameters or configuration parameter vectors, respectively, is performed by the DMA independently of the system processor, which will be discussed in more detail below.

The data source of the configuration parameter vectors is the system memory, where the corresponding sets of configuration parameters were stored in the storing step. In this case, the system memory represents also the data source of the configuration parameters in the step of transferring the configuration parameters to the processing means 13 of the GHA.

After the re-configuration of the processing means 13 of the GHA and after performance of the function F on transferred data 17, the result vectors are written into a result memory 12 as data destination, which may also be an area of the system memory. The result data 18 or result vectors, respectively, are transferred from the processing 13 of the GHA to the data destination via a DMA channel, which will be discussed in more detail below.

The result vectors r[k] are written to the result memory 12 which is partitioned into vectors R(aᵣ):

R(aᵣ[k])=r[k] (3),

wherein the index aᵣ identifies a sequence of samples from R, which may be arbitrarily scattered but which are often consecutive. The indices aᵣ are generated by FSMᵣ.

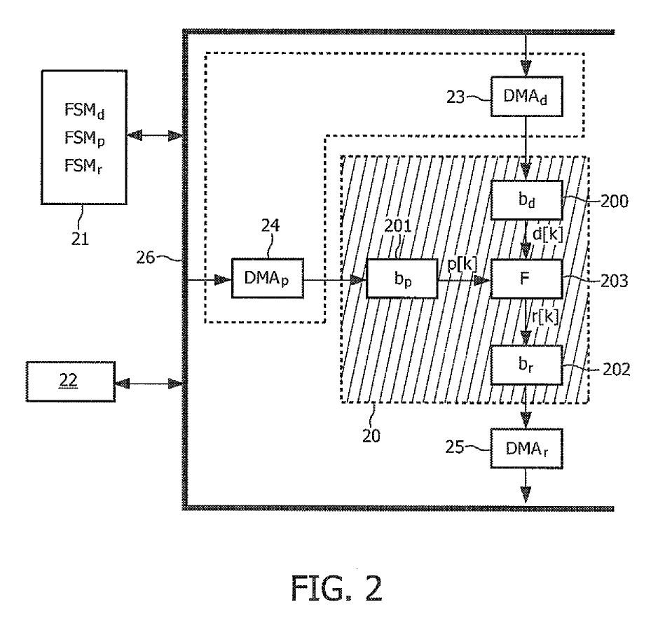

Now referring to FIG. 2, illustrated therein is the attachment of the GHA 20 to the processor system. Now, re-configuration of the processing device 203 of the GHA 20 with sets of configuration parameters, which in this example include algorithmic configuration parameter vectors p[k], will be described, wherein the algorithmic configuration parameter vectors p[k] are transferred via the DMA. In other words, the core function F of the processing device 203 of the GHA 20 is re-configured by means of the algorithmic configuration parameter vectors p[k], in short parameter vectors p[k] in the following.

In this embodiment, input and output buffers of the GHA 20 are memory mapped to the memory 22. Sets of parameter vectors, input data vectors, and result vectors, p[k], d[k], and r[k], are transferred via DMA channels 23, 24, and 25 connected by a system bus 26.

The parameter vectors p[k] are pre-computed and stored in the system memory 22 of the processor system by the finite state machine FSMₚ. Finite state machines FSMₚ, FSM_{d}, FSMᵣ are shown in the area of a processor 21. In the processor 21 the FSMₚ, FSM_{d}, FSMᵣ are implemented in software on processor 21, wherein the configuration parameter vectors are generated by the FSMₚ. Of course, alternative implementations of the corresponding FSMs are possible.

The parameter vectors p[k] and the data vectors d[k] are transferred from respective sources, preferably the system memory 22, to the GHA 20 via DMA channels 24 and 23. The DMA channel 24 is used to transfer the parameter vectors p[k] and DMA channel 23 is used to transfer the data vectors d[k] to the GHA 20. Thus, the advantage of autonomy and flexibility at a reasonable complexity of the control circuitry of the GHA 20 is achieved.

It is worth noting that the DMA channels 24 and 23 may alternatively be merged into a single DMA channel DMA_{d/p}, which is indicated by the dashed lines around the DMA channels 24 and 25, in FIG. 2. Such configuration, for instance, may be applicable when DMA channels are provided, which are able to support linked lists of parameter vectors p[k] and data vectors d[k].

Before execution of the function F by the processing device 203 of the GHA 20 the data and/or the configuration parameters may be buffered in buffers b_{d} and bₚ of the GHA 20, wherein the corresponding buffers are placed in an appropriate buffer device 200 and 201 of the GHA 20. After processing of the data by the processing device 203 of the GHA 20, performing the function F, the result data or processed data also may be buffered in a buffer bᵣ, placed in an appropriate buffer device 201 of the GHA 20.

After performance of the function F, the GHA 20 transfers the respective result data, that is the result vectors r[k], via the DMA channel 25. For example, the result data may be transferred into the system memory 22 or alternatively to another hardware element or component for further processing (not shown). There are several alternatives concerning the destination of the data, depending of the concrete situation and concrete application.

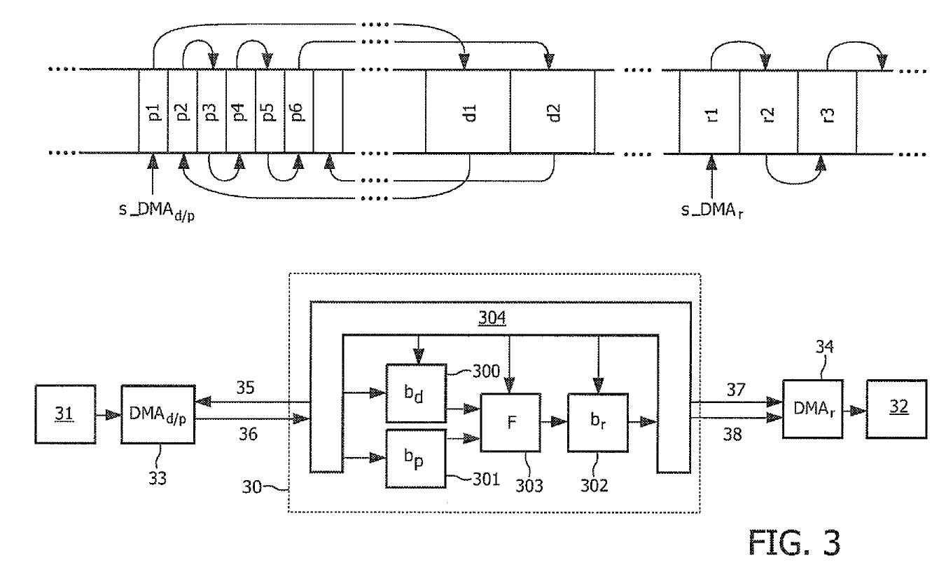

Now with reference to FIG. 3, the transfer of sets of configuration parameters and data 36 from the memory device 31 to the GHA 30 and for transfer of result data 38 from the GHA 30 to memory device 32 via respective DMA channels 33 and 34 is described. A direct memory access via the DMA channels 33 and 34 can be initiated by respective DMA requests 35 and 37 from the GHA 30. Hence, the GHA 40 is able to access both memory device 31 and memory device 32 without involvement of the system processor of the GPS receiver. Preferably, source memory 31 and destination memory 32 are the same, namely the system memory. The data transfer via the DMA channels 33 and 34 is controlled by a flow control 304.

As already mentioned in connection with FIG. 2, the channel DMAₚ for the transfer of the configuration parameters and the channel DMA_{d} for the transfer of data to be processed by the GHA 30 may be merged into a single DMA channel DMA_{d/p}, which is the case in the embodiment shown in FIG. 3. Merging of the DMA channels DMAₚ and DMA_{d} is especially applicable, if the DMA channel supports linked lists by which data in the memory is organized such that each data element is linked via a pointer to the next data element. The concept of linked lists is well known.

The above part of FIG. 3 shows partially a memory map of, for example, the system memory. In the system memory are sequentially organized sets of configuration parameters represented by corresponding configuration parameter vectors p1, p2, . . . , p6 and data sets represented by corresponding data vectors d1, d2, . . . . The start address in the system memory for the configuration parameter vectors p1, p2, . . . , p6 and data vectors d1, d2, . . . is denoted by s_DMA_{d/p}. In operation, the configuration parameter vectors p1, p2, . . . , p6 and the data vectors d1, d2, . . . are transferred as data 36 via the DMA channel 33 on a respective DMA request 35.

Operation of the GHA will now be described in connection with FIG. 3. The configuration parameter vector p1, for instance, includes a command for pulling data vector d1 into the local buffer b_{d} of buffer device 300. Then, a corresponding result vector r1 is computed by the processor 303 of the GHA 30 in accordance with the configuration parameter vector p1, by which the function F has been re-configured. The result data represented by the result vector r1 is finally pushed via DMA channel 33 into a result data destination 32, which here again includes the system memory. In the memory map of FIG. 3 above, s_DMAᵣ denotes the start address of result data 38 transferred by the DMA channel 34.

As can be gathered from the arrays in FIG. 3, depicting pointers linking the data elements (configuration parameter vectors and data vectors) in the memory map, the consecutive configuration parameter vectors p2 to p5 reuse the data vector d1 stored in the local buffer. Next, configuration parameter vector p6 contains a command for pulling next data vector d2 into the local buffer b_{d} of the buffer device 300.

It is noted that although the example of the memory map of FIG. 3 shows sequential storage of result vectors, scattered or interleaved storage may also be employed as well.

In summary, a flexible, less complex and autonomously operating method, components, and a system have been presented, where a hardware peripheral like an hardware accelerator, a co-processor, or a peripheral with co-processor behavior for a processor system can be re-configured. By at least one set of configuration parameters the hardware peripheral can be re-configured via direct memory access independently of a system processor. Additionally, data sources or data destinations, for example the system memory, or another component within or outside the system, is accessed independently of the system processor. Furthermore, the re-configuration method enables flexible assembling and storing of the at least one set of configuration parameters used for the re-configuration of the hardware peripheral. Thus, the present disclosure provides flexible and fast handling of large amounts of temporary data independently of a processor.

It is to be noted that the description of the disclosure shall not be seen as limitation to the disclosure. Basically, the inventive principles of the present disclosure may be applied to any data processor system where data is subject to processing by a re-configurable function.

While there have been shown and described and pointed out fundamental features of the disclosure as applied to the preferred embodiment thereof, it will be understood that various omissions and substitutions and changes in the form and details of the devices and methods described may be made by those skilled in the art without departing from the present disclosure. For example, it is expressly intended that all combinations of those elements and/or method steps, which perform substantially the same function in substantially the same way to achieve the same results, are within the scope of the disclosure. Moreover, it should be recognized that structures and/or elements and/or method steps shown and/or described in connection with any disclosed form or embodiment of the disclosure may be incorporated in any other disclosed or described or suggested form or embodiment as a general matter of design choice. It is the intention, therefore, to be limited only as indicated by the scope of the claims appended hereto.

Finally but yet importantly, it is noted that the term “comprises” or “comprising” when used in the specification including the claims is intended to specify the presence of stated features, devices, steps or components, but does not exclude the presence or addition of one or more other features, devices, steps, components or group thereof. Further, the word “a” or “an” preceding an element in a claim does not exclude the presence of a plurality of such elements. Moreover, any reference sign does not limit the scope of the claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for re-configuration of a hardware peripheral performing at least one function for a system with at least one processor, wherein the method comprises: transferring a set of configuration parameters for the hardware peripheral from at least one first data source to the hardware peripheral via at least one first DMA channel; and re-configuring the hardware peripheral with the set of configuration parameters.

2. The method according to claim 1, wherein the method further comprises transferring data to be processed by the hardware peripheral from at least one second data source to the hardware peripheral via at least one second DMA channel.

3. The method according to claim 1, wherein the method further comprises transferring data processed by the hardware peripheral to at least one data destination from the hardware peripheral via at least one third DMA channel.

4. The method according to claim 1, further comprising setting up the hardware peripheral by assembling at least one set of configuration parameters for the hardware peripheral in at least one data pre-processor; and storing the least one set of configuration parameters in at least one memory device.

5. The method according to claim 4, wherein in the assembling step the at least one set of configuration parameters is stored in a processor memory.

6. The method according to claim 4, wherein in the storing step the at least one set of configuration parameters is stored in a system memory.

7. The method according to claim 1, wherein in the assembling step at least one finite state machine is configured to generate a plurality of sets of configuration parameters in a predetermined order.

8. The method according to claim 1, wherein the assembling step further comprises arranging more than one set of configuration parameters and the data to be processed as a linked list.

9. A hardware peripheral for performing at least one function for a system with at least one processor, wherein the hardware peripheral is configured to receive a set of configuration parameters for re-configuration of the at least one function from at least one first data source via at least one first DMA channel; and wherein the hardware peripheral is configured to be re-configured with the received set of configuration parameters.

10. The hardware peripheral according to claim 9, wherein the hardware peripheral comprises means for transferring data to be processed to the hardware peripheral from at least one second data source to the hardware peripheral via at least one second DMA channel.

11. The hardware peripheral according to claim 9, wherein the hardware peripheral comprises means for transferring data processed from the hardware peripheral to at least one data destination via at least one third DMA channel.

12. The hardware peripheral according to claim 9, wherein at least one of the data to be processed and the at least one set of configuration parameters are arranged as respective linked lists in the at least one first data source and second data source, respectively.

13. The hardware peripheral according to claim 9, wherein the hardware peripheral is a hardware accelerator or a peripheral with co-processor behavior.

14. The hardware peripheral according to claim 9, wherein the hardware peripheral is a GPS hardware accelerator.

15. The hardware peripheral according to claim 9, wherein the first and second data source and the data destination are located in a single memory such that the first, second, and third DMA channels are connected to a single memory.

16. The hardware peripheral according to claim 15, wherein the single memory is the system memory of the system with the at least one processor.

17. A system for processing a high amount of temporary data, the system comprising at least one processor and a hardware peripheral configured to receive a set of configuration parameters for re-configuration of the at least one function from at least one first data source via at least one first DMA channel; and wherein the hardware peripheral is configured to be re-configured with the received set of configuration parameters; and means for transferring data to be processed to the hardware peripheral from at least one second data source to the hardware peripheral via at least one second DMA channel, such that processor load caused by handling of the high amount of temporary data is reduced.

18. The system according to claim 17, wherein the system comprises at least one device for assembling at least one set of configuration parameters for re-configuration of the hardware peripheral.

19. A circuit for use with at least one processor in performing at least one function, the circuit comprising:
a hardware accelerator for a peripheral having co-processor behavior;
at least one DMA channel adapted to receive data regarding the function on an input and to output the data to the accelerator; and
at least one second DMA channel adapted to transfer data from the accelerator to at least one data destination for reconfiguration of the function.

20. The circuit of claim 19, wherein the source of data input to the DMA channel and the destination of the data output through the at least second DMA channel comprises a single memory.

21. The circuit of claim 20, wherein the data input through the DMA channel and output through the at least second DMA channel is sent and received independent of an external processor.
